(19) United States
(12) Patent Application Publication
(10) Pub. No.: US 2008/0312915 A1
(43) Pub. Date: Dec. 18, 2008

(54) Audio Encoding

(75) Inventors: Albertus Cornelis Den Brinker, Eindhoven (NL); Andreas Johannes Gerrits, Eindhoven (NL); Felipe Riera Palou, Palma de Mallorca (ES)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,779

(22) PCT Filed: Jun. 3, 2005
(86) PCT No.: PCT/IB2005/051821

§ 371 Date: Aug. 26, 2008

(30) Foreign Application Priority Data
Jun. 8, 2004 (EP) 04102576.8

(51) Int. Cl. G10L 19/04; G10L 19/14

(52) U.S. Cl. 704/219; 704/500; 704/201; 704/E19.023

(57) ABSTRACT

A hybrid sinusoidal/pulse excitation encoder has been recently proposed for constructing a scalable audio encoder The base layer consisting of data supplied by the sinusoidal encoder retains the main features of the input signal achieving medium to high quality audio at a very low bit rate. Quality can be further enhanced by adding excitation signal layers associated with a decreasing decimation that increasingly model more subtle aspects of the original signal. The invention provides a method of mixing the different excitation signal layers so that the full concept of scalability is realised without compromising the quality of the encoded signals. The mixing is controlled via a quality parameter that weights the significance of previous layers when constructing a new higher layer.

The present invention relates to encoding and decoding of broadband signals, in particular audio signals. The invention relates both to an encoder and a decoder, and to an audio stream encoded in accordance with the invention and a data storage medium on which such an audio stream has been stored.

When transmitting broadband signals, e.g. audio signals such as speech, compression or encoding techniques are used to reduce bit rate of the signal. Reducing the bit rate is equivalent to reducing the bandwidth needed for transmission.

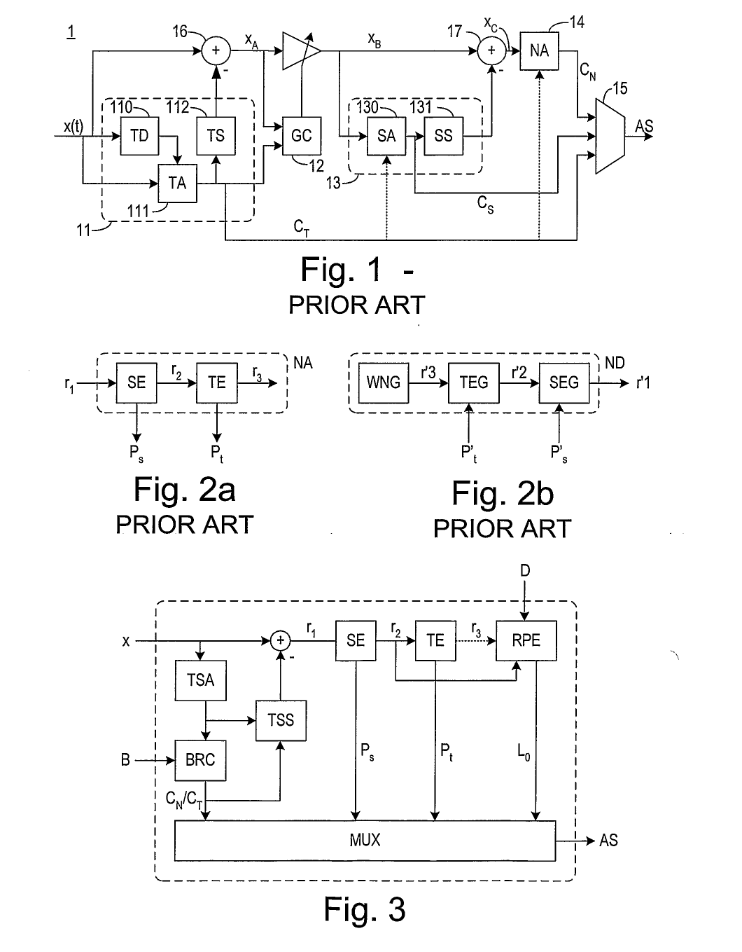

FIG. 1 shows a schematic diagram of a known parametric encoder, in particular a sinusoidal encoder, which is used in the present invention, and which is described in WO 01/69593. In this encoder, an input audio signal x(t) is split into several (possibly overlapping) time segments or frames, typically of duration 20 ms each. Each segment is decomposed into transient, sinusoidal and noise components, and parameters describing these signal components are generated, C_{T}, C_{S} and C_{N}, respectively. It is also possible to derive other components of the input audio signal such as harmonic complexes although these are not relevant for the purposes of the present invention.

The first stage of the encoder comprises a transient encoder 11 including a transient detector (TD) 110, a transient analyzer (TA) 111 and a transient synthesizer (TS) 112. The detector 110 estimates if there is a transient signal component and its position. This information is fed to the transient analyzer 111. If the position of a transient signal component is determined, the transient analyzer 111 tries to extract the transient signal component or the most significant part thereof. It matches a shape function to a signal segment preferably starting at an estimated start position, and determines content underneath the shape function, by employing for example a (small) number of sinusoidal components. This information is contained in the transient code C_{T}.

The transient code C_{T} is furnished to the transient synthesizer 112. The synthesized transient signal component is subtracted from the input signal x(t) in subtractor 16, resulting in a signal x_{A}. A gain control mechanism GC (12) is used to produce x_{B} from x_{A}. The signal x_{B} is fed to a sinusoidal encoder 13 where it is analyzed in a sinusoidal analyzer (SA) 130, which determines the sinusoidal components i.e. the deterministic components. The end result of sinusoidal encoding is a sinusoidal code C_{S} and a more detailed example illustrating the conventional generation of an exemplary sinusoidal code C_{S} is provided in international patent application publication No. WO 00/79519 A1.

From the sinusoidal code C_{S} generated with the sinusoidal encoder the sinusoidal signal component is reconstructed by a sinusoidal synthesizer (SS) 131. This signal is subtracted in subtractor 17 from the input x_{B} to the sinusoidal encoder 13, resulting in a remaining signal x_{C} devoid of (large) transient signal components and (main) deterministic sinusoidal components.

The remaining signal x_{C} is assumed to mainly comprise noise and a noise analyzer 14 produces the noise code C_{N} representative of this noise, as described in WO 01/89086A1.

FIGS. 2(a) and (b) show generally the form of an encoder (NA) suitable for use as the noise analyzer 14 of FIG. 1 and a corresponding decoder (ND). A first audio signal r₁, corresponding to the residual x_{C} of FIG. 1, enters the noise encoder comprising a first linear prediction (SE) stage which spectrally flattens the signal and produces prediction coefficients (Ps) of a given order. More specifically, a Laguerre filter can be used to provide frequency depending flattening of the signal as disclosed in E. G. P. Schuijers, A. W. J. Oomen, A. C. den Brinker and A. J. Gerrits, “Advances in parametric coding for high-quality audio”, Proc. 1st IEEE Benelux Workshop on Model based Processing and Coding of Audio (MPCA-2002), Leuven, Belgium, 15 Nov. 2002, pp. 73-79. The residual r₂ enters a temporal envelope estimator (TE) producing a set of parameters Pt and, possibly, a temporally flattened residual r₃. The parameters Pt can be a set of gains describing the temporal envelope. Alternatively, they may be parameters derived from Linear Prediction in the frequency domain such as Line Spectral Pairs (LSPs) or Line Spectral Frequencies (LSFs), describing a normalised temporal envelope, which is then augmented with a gain parameter per frame.

In the parametric noise decoder (ND), a synthetic white noise sequence is generated (in WNG) resulting in a signal r₃′ with a temporally and spectrally flat envelope. A temporal envelope generator (TEG) adds the temporal envelope on the basis of the received, quantised parameters Pt′ thereby generating r′₂, and a spectral envelope generator (SEG, a time-varying filter) adds the spectral envelope on the basis of the received, quantised parameters Pₛ′ resulting in a noise signal r₁′.

In a multiplexer 15, an audio stream AS is constituted which includes the codes C_{T}, C_{S} and C_{N}. The sinusoidal encoder 13 and noise analyzer 14 are used for all or most of the segments and amount to the largest part of the bit rate budget.

It is well known that parametric audio coders can give a fair to good quality at relatively low bit rates, for example 20 kbit/s. However, at higher bit rates the quality increase, as a function of increasing bit rate is rather low. Thus, an excessive bit rate is needed to obtain excellent or transparent quality. It is therefore difficult to attain transparency using parametric encoding at bit rates comparable to those of, for example, waveform coders. This means that it is difficult to construct parametric audio coders having an excellent to transparent quality without an excessive usage of bit budget.

The reason for the fundamental difficulty in parametric encoding reaching transparency lies in the objects that are defined. The parametric encoder is very efficient in encoding tonal components (sinusoids) and noise components (noise encoder). However, in real audio a lot of signal components fall into a grey area: they can neither be modelled accurately by noise nor can they be modelled as (a small number of) sinusoids. Therefore, the very definition of objects in a parametric audio encoder, though very beneficial from a bit rate point of view for medium quality levels, is the bottleneck in reaching excellent or transparent quality levels.

At the same time, traditional audio coders (sub-band and transform) give excellent to transparent encoding quality at certain bit rates, typically in the order of 80-130 kbit/s for stereo signals sampled at 44.1 kHz. Combinations of transform and parametric coders (so-called hybrid coders) have been proposed for example as disclosed in European patent application no. 02077032.7 filed on May 24, 2002. Here spectro-temporal intervals of an audio signal, which would otherwise be sub-band coded, are selectively coded with noise parameters in an attempt to reduce bit rate while maintaining audio quality.

Alternatively, a transform or sub-band encoder might be cascaded with a parametric encoder of the type shown in FIG. 1. However, the expected encoding gain for such an arrangement, where the parametric encoder is preceding the transform or sub-band encoder, is minimal. This is because the perceptually most important regions of the audio signal would be captured by the sinusoidal encoder, leaving little possibility for encoding gain in the transform/sub-band encoder.

Audio coders using spectral flattening and residual signal modelling using a small number of bits per sample are disclosed in A. Harma and U. K. Laine, “Warped low-delay CELP for wide-band audio coding”, Proc. AES 17th Int. Conf.: High Quality Audio Coding, pages 207-215, Florence, Italy, 2-5 Sep., 1999; S. Singhal, “High quality audio coding using multi-pulse LPC”, Proc. 1990 Int. Conf. Acoustic Speech Signal Process. (ICASSP9O), pages 1101-1104, Atlanta Ga., 1990, IEEE Piscataway, N.J.; and X. Lin, “High quality audio coding using analysis—by synthesis technique”, Proc. 1991 Int. Conf. Acoustic Speech Signal Process. (ICASSP91), pages 3617-3620, Atlanta OA, 1991, JEEE Piscataway, N.J. In a number of studies, it has been shown that this encoding strategy enables an excellent to transparent quality at bit rates corresponding to 2 bit/sample for mono signals (88.2 kbit/s for 44.1 kHz audio). In that respect, they do not exceed the performance of sub-band or transform coders.

The possibility of scaling the bit stream appears to be very attractive in applications where audio material should offer the possibility of being accessed at different signal qualities or bit rates as it is often the case in music distribution. Bit stream scalability allows the content provider to store just one version of the encoded material. Another interesting application could be the use of the first (base) layer of the encoded signal to provide audio “thumbnails”, where subsequent access to the full version of the file will not require retransmission of the of the base layer material. RPE-based coders for creating layered bit streams are disclosed in S. Zhang and G. Lockhart, “Embedded RPE based on multistage coding”, IEE Transactions on Speech and Audio Processing, Vol. 5 (4), 367-371, 1997.

The inventors have appreciated that the known techniques for creating layered bit streams are hampered in quality due to scalability loss. The object of the present invention is to mitigate the loss of quality when creating a layered bit stream.

The invention thus relates to a method of encoding a digital audio signal, wherein for each time segment of the signal the following steps are performed:

encoding the audio signal to provide codes representing the audio signal, subtracting a signal corresponding to the codes from the audio signal to obtain a first residual signal,

spectrally flattening the first residual signal to obtain a spectrally flattened residual signal (r) and spectral flattening parameters,

calculating, using a pulse train encoder, a first excitation signal from the spectrally flattened residual signal,

determining the quality of the first excitation signal as its degree of resemblance with the spectrally flattened residual signal,

subtracting a part of the first excitation signal from the spectrally flattened residual signal, to obtain a second residual signal, where the part depends on the determined quality of the first excitation signal,

calculating, using a pulse train encoder, a second excitation signal from the second residual signal, and

generating an audio stream comprising:
the first excitation signal,
the second excitation signal, and
a parameter indicative of the quality of the first excitation signal.

The invention also relates to an audio encoder using the above method and thus being adapted to encode respective time segments of a digital audio signal, the encoder comprising:

an encoder for encoding the digital audio signal to provide codes representing the signal,

a subtractor for subtracting a signal corresponding to the codes from the audio signal to obtain a first residual signal,

a spectral flattening unit for spectrally flattening the first residual signal to obtain a spectrally flattened residual signal and spectral flattening parameters,

a pulse train encoder for calculating a first excitation signal for the spectrally flattened residual signal,

means for determining the quality of the first excitation signal as its degree of resemblance with the spectrally flattened residual signal,

a subtractor for subtracting a part of the first excitation signal from the spectrally flattened residual signal, to obtain a second residual signal, where the part depends on the determined quality of the first excitation signal,

a pulse train encoder for calculating a second excitation signal for the second residual signal, and

a bit stream generator for generating an audio stream comprising:
the first excitation signal,
the second excitation signal, and
a parameter indicative of the quality of the first excitation signal.

Further, the invention relates to a method of decoding a received audio stream such as an audio stream encoded using the above method or encoder, where the audio stream comprises for each of a plurality of segments of an audio signal:

a first excitation signal,

a second excitation signal, and

a parameter indicative of the quality of the first excitation signal, the method comprising

combining, in dependence on the quality parameter, the first and second excitation signals to obtain a combined excitation signal, and

synthesizing from the combined excitation signal, using a linear prediction synthesis filter, a first residual signal.

Correspondingly, the invention relates to an audio player for receiving and decoding an audio stream, where the audio stream comprises for each of a plurality of segments of an audio signal:

a first excitation signal,

a second excitation signal, and

a parameter indicative of the quality of the first excitation signal, the audio player comprising

means for combining, in dependence on the quality parameter, the first and second excitation signals to obtain a combined excitation signal, and

means for synthesizing from the combined excitation signal, using linear prediction, a first residual signal.

Finally, the invention relates to an audio stream comprising for each of a plurality of segments of an audio signal:

a first excitation signal resulting from pulse train encoding of a spectrally flattened residual signal, the residual signal resulting from subtracting an encoded audio signal from the audio signal,

a second excitation signal resulting from pulse train encoding of a second residual signal, said signal generated by subtracting a part of the first excitation signal from the spectrally flattened residual signal, where the part depends on a determined quality of the first excitation signal, and

a parameter indicative of the determined quality of the first excitation signal; and to a storage medium having such an audio stream stored thereon.

Embodiments of the invention will now be described, by way of example, with reference to the accompanying drawings, in which:

FIG. 1 shows a conventional parametric encoder;

FIGS. 2a and 2b show a conventional parametric noise encoder (NA) and corresponding noise decoder (ND), respectively;

FIG. 3 shows an overview of an encoder;

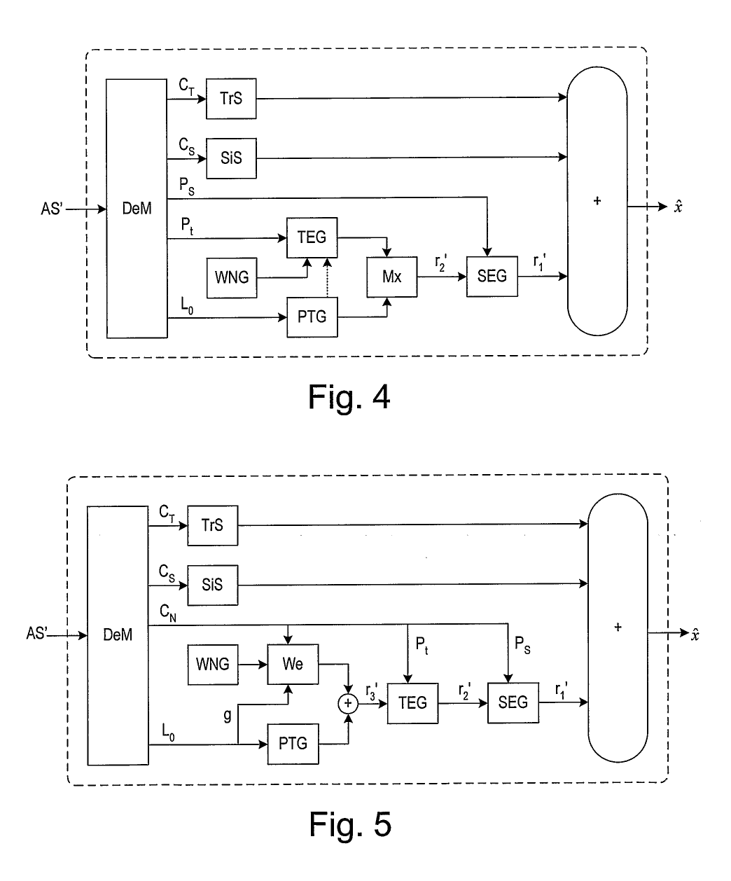

FIG. 4 shows an overview of a first decoder that is compatible with the encoder of FIG. 3;

FIG. 5 shows an overview of a second decoder that is compatible with the encoder of FIG. 3;

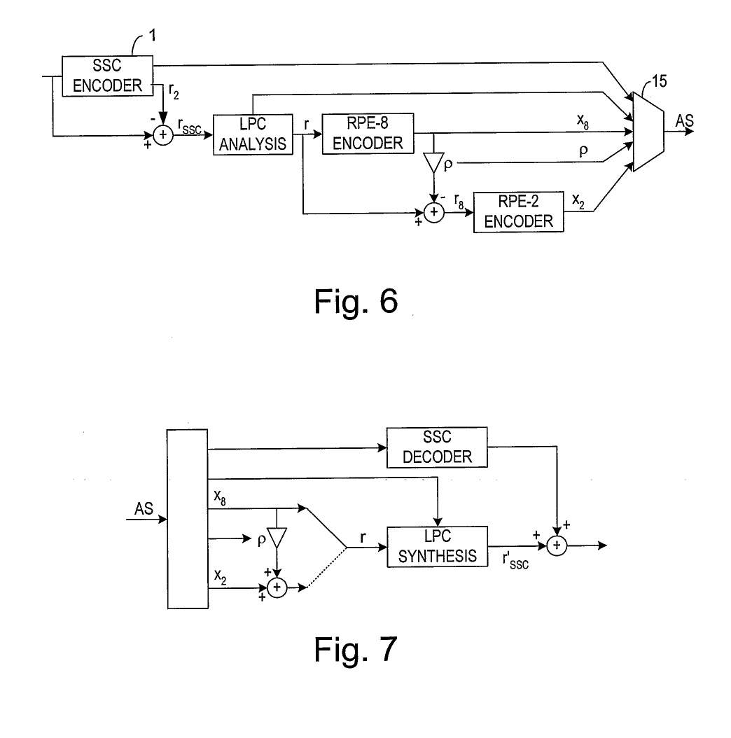

FIG. 6 shows a schematic diagram of an encoder in accordance with the invention; and

FIG. 7 shows a schematic diagram of a decoder in accordance with the invention.

FIGS. 1-5 and the corresponding description reflect the disclosure in non prepublished European patent application number 03104472.0 which was filed on Dec. 1, 2003 (applicants internal reference number PHNLO31414EPP).

In FIG. 1 is illustrated a sinusoidal encoder 1 of the type described in WO 01/69593, and which is used in a preferred embodiment of the present invention. The operation of this prior art encoder and its corresponding decoder has been well described and description is only provided here where relevant to the present invention.

The audio encoder 1 receives a digital audio signal x(t) sampled at a certain sampling frequency. The encoder 1 then separates the sampled input signal into three components: transient signal components, sustained deterministic components, and sustained stochastic components. The audio encoder 1 comprises a transient encoder 11, a sinusoidal encoder 13 and a noise encoder 14.

The transient encoder 11 comprises a transient detector (TD) 110, a transient analyzer (TA) 111 and a transient synthesizer (TS) 112. First, the signal x(t) enters the transient detector 110. This detector 110 estimates if there is a transient signal component and its position. This information is fed to the transient analyzer 111. If the position of a transient signal component is determined, the transient analyzer 111 tries to extract (the main part of) the transient signal component. It matches a shape function to a signal segment preferably starting at an estimated start position, and determines content underneath the shape function, by employing for example a (small) number of sinusoidal components. This information is contained in the transient code C_{T}, and more detailed information on generating the transient code C_{T} is provided in WO 01/69593.

The transient code C_{T} is furnished to the transient synthesizer 112. The synthesized transient signal component is subtracted from the input signal x(t) in subtractor 16, resulting in a signal x_{A}. A gain control mechanism GC (12) is used to produce x_{B} from x_{A}.

The signal x_{B} is furnished to the sinusoidal encoder 13 where it is analyzed in a sinusoidal analyzer (SA) 130, which determines the (deterministic) sinusoidal components. It will therefore be seen that while the presence of the transient analyser is desirable, it is not necessary and the invention can be implemented without such an analyser. Alternatively, as mentioned above, the invention can also be implemented with for example a harmonic complex analyser. In brief, the sinusoidal encoder encodes the input signal x_{B} as tracks of sinusoidal components linked from one frame segment to the next.

The encoder as shown in FIG. 3 is supplemented with a pulse train encoder of the type described in P. Kroon, E. F. Deprettere and R. J. Sluijter, “Regular Pulse Excitation—A novel approach to effective and efficient multipulse coding of speech”, IEEE Trans. Acoust. Speech, Signal Process, 34, 1986. Nonetheless, it will be seen that while the embodiment is described in terms of a Regular Pulse Excitation (RPE) encoder, it can equally be implemented with Multi-Pulse Excitation (MPE) techniques as disclosed in U.S. Pat. No. 4,932,061 or an ACELP encoder as described K. Jarvinen, J. Vainio, P. Kapanen, T. Honkanen, P. Haavisto, R. Salami, C. Laflamme, J-P. Adoul, “GSM enhanced full rate speech codec”, Proc. ICASSP-97, Munich (Germany), 2 1-24 Apr. 1997, Volume 2, pp. 77 1-774, each of which include a first LP based spectral flattening stage.

In the encoder as shown in FIG. 3, an overall bit rate budget determined according to the quality required from the encoder, is divided into a bit-rate B usable by the parametric encoder and an RPE encoding budget from which an RPE decimation factor D can be derived.

In FIG. 3 an input audio signal x is first processed within block TSA, (Transient and Sinusoidal Analysis) corresponding with blocks 11 and 13 of the parametric encoder of FIG. 1. Thus, this block generates the associated parameters for transients and noise as described in FIG. 1. Given the bit rate B, a block BRC (Bit Rate Control) preferably limits the number of sinusoids and preferably preserves transients such that the overall bit rate for sinusoids and transients is at most equal to B, typically set at around 20 kbit/s.

A waveform is generated by block TSS (Transient and Sinusoidal Synthesiser) corresponding to blocks 112 and 131 of FIG. 1 using the transient and sinusoidal parameters (C_{T} and C_{S}) generated by block TSA and modified by the block BRC. This signal is subtracted from input signal x, resulting in signal r₁ corresponding to residual x_{C} in FIG. 1. In general, signal r₁ does not contain substantial sinusoids and transient components.

From signal r₁, the spectral envelope is estimated and removed in the block (SE) using a Linear Prediction filter, e.g. based on a tapped-delay-line or a Laguerre filter as in the prior art FIG. 2(a). The prediction coefficients Ps of the chosen filter are written to a bit stream AS for transmittal to a decoder as part of the conventional type noise codes C_{N}. Then the temporal envelope is removed in the block (TE) generating, for example, Line Spectral Pairs (LSP) or Line Spectral Frequencies (LSF) coefficients together with a gain, again as described in the prior art FIG. 2(a). In any case, the resulting coefficients Pt from the temporal flattening are written to the bit stream AS for transmittal to the decoder as part of the conventional type noise codes C_{N}. Typically, the coefficients P_{S} and P_{T} require a bit rate budget of 4-5 kbit/s.

Because pulse train coders employ a first spectral flattening stage, the RPE encoder can be selectively applied on the spectrally flattened signal r₂ produced by the block SE according to whether a bit rate budget has been allocated to the RPE encoder. In an alternative embodiment, indicated by the dashed line, the RPE encoder is applied to the spectrally and temporally flattened signal r₃ produced by the block TE.

As is known from the documents referred to in the background, the RPE encoder performs a search in an analysis-by-synthesis manner on the residual signal r₂/r₃. Given a decimation factor D, the RPE search procedure results in an offset (value between 0 and D1, where D1 depends on D), the amplitudes of the RPE pulses (for example, ternary pulses with values −1, 0 and 1) and a gain parameter. This information is stored in a layer L₀ included in the audio stream AS for transmittal to the decoder by a multiplexer (MUX) when RPE encoding is employed.

The RPE encoder is operable at different bit rates and supplies correspondingly different quality levels. The bit rate is effectively tuneable by the decimation factor D and the quantisation grid, and by correctly setting these parameters a monotonically increasing quality is obtained at increasing bit rates, so that it is competitive to the state-of-the-art encoders over a substantial range of bit rates.

Experiments have shown that the RPE encoder sometimes results in a loss in brightness in the reconstructed signal when using high decimation factors (e.g. D=8). Adding some low-level noise to the RPE sequence mitigates this problem. In order to determine the level of the noise, a gain (g) is calculated on basis of, for example, the energy/power difference between a signal generated from the coded RPE sequence and residual signal r₂/r₃. This gain is also transmitted to the decoder as part of the layer L₀ information.

In FIG. 4 is shown a decoder that is compatible with the encoder of FIG. 3. A de-multiplexer (DeM) reads an incoming audio stream AS′ and provides the sinusoidal, transient and noise codes (C_{S}, C_{T} and C_{N}(Ps, Pt)) to respective synthesizers SiS, TrS and TEG/SEG as in the prior art. As in the prior art, a white noise generator (WNG) supplies an input signal for the temporal envelope generator TEG. In the embodiment, where the information is available, a pulse train generator (PTG) generates a pulse train from layer L₀ and this is mixed in block Mx with the noise signal outputted by TEG to provide an excitation signal r₂′. It will be seen from the encoder, that as the noise codes C_{N} (Ps, Pt) and layer L₀ were generated independently from the same residual r₂, the signals they generate need to be gain modified to provide the correct energy level for the synthesized excitation signal r₂′. In this embodiment, in a mixer (Mx), the signals produced by the blocks TEG and PTG are combined.

The excitation signal r₂′ is then fed to a spectral envelope generator (SEG) which according to the codes Ps produces a synthesized noise signal r₁′. This signal is added to the synthesized signals produced by the conventional transient and sinusoidal synthesizers to produce the output signal \hat{x}.

In an alternative embodiment, the parameters generated by the pulse train generator PTG are used (indicated by the hashed line) in combination with the noise code Pt to shape the temporal envelope of the signal outputted by WNG to create a temporally shaped noise signal.

In FIG. 5 is shown a second embodiment of the decoder that corresponds with the embodiment of FIG. 3 where the RPE block processes the residual signal r₃. Here, the signal generated by a white noise generator (WNG) and processed by a block We, based on the gain (g) and C_{N} determined by the encoder; and the pulse train generated by the pulse train generator (PTG) are added to construct an excitation signal r₃′. Of course, where layer L₀ information is not available, the white noise is unaffected by the block We and provided as the excitation signal r₃′ to a temporal envelope generator block (TEG).

The temporal envelope coefficients (Pt) are then imposed on the excitation signal r₃′ by the block TEG to provide the synthesized signal r₂′ which is processed as before. As mentioned above, this is advantageous because a pulse train excitation typically gives rise to some loss in brightness which, with a properly weighted additional noise sequence, can be counteracted. The weighting can comprise simple amplitude or spectral shaping each based on the gain factor g and C_{N}.

As before, the signal is filtered by, for example, a linear prediction synthesis filter in block SEG (Spectral Envelope Generator), which adds a spectral envelope to the signal. The resulting signal is then added to the synthesized sinusoidal and transient signal as before.

It will be seen that in either FIG. 4 or FIG. 5, if no PTG is being used, the decoding scheme resembles the conventional sinusoidal encoder using a noise encoder only. If the PTG is used, a RPE sequence is added, which enhances the reconstructed signal i.e. provides a higher audio quality.

It should be noted that in the embodiment of FIG. 5, in contrast to the standard pulse encoder (RPE or MPE), where a gain which is fixed for a complete frame is used, a temporal envelope is incorporated in the signal r₂′. By using such a temporal envelope, a better sound quality can be obtained, because of the higher flexibility in the gain profile compared to a fixed gain per frame.

The hybrid method described above can operate at a wide variety of bit rates, and at every bit rate it offers a quality comparable to that of state-of-the-art encoders. In that method the base layer, which is made up by the data supplied by the parametric (sinusoidal) encoder, contains the main or basic features of the input signal, and that method medium to high quality audio signal is obtained at a very low bit rate.

It is preferred however, that the created bit stream is scalable such that layers can be extracted. It is assumed that we have ordered layers. Consequently it is desirable that the encoder is able to constructively add the information to attain optimum quality for a given bit rate. The layering of the bit stream usually implies a decrease in quality (so-called scalability loss) induced by the requirement of a scalable bit stream. This invention tries to mitigate this problem. For this reason, encoder, decoder and bit stream are adapted.

In the following a description is given of a method according to the invention in which mixing the different excitation signal layers is performed in the decoder so that the full concept of scalability is realised without compromising the quality of the coded signals. The mixing is controlled via a one or more parameters determined in the encoder and stored in the bit stream. These parameters reflect the significance of previous layers when constructing a new higher layer.

FIG. 6 shows a fully scalable combined parametric (sinusoidal) and waveform (pulse) encoder according to the invention. It is noted that the invention can use any other encoder than the one described here. An input signal is received in a parametric encoder, which in the shown embodiment is a sinusoidal SSC encoder 1 as in FIG. 1. The residual r_{SSC} from the SSC encoder is first spectrally flattened, preferably using LPC analysis, whereby its dynamic range is reduced, which in turn reduces errors in quantisation steps. The spectrally flattened residual signal r is then fed to a first waveform encoder, here an RPE-8 stage with decimation factor 8, which produces a first excitation signal x₈ from the spectrally flattened residual signal r.

A new residual signal r₈ is created by combining the residual signal r and the already calculated excitation signal x₈. In particular, r₈ is defined as the difference between the original residual signal r and the weighted excitation x₈ according to

r₈=r−ρx₈

The parameter ρ is optimised so that the combined layers achieve maximum quality.

We note that setting ρ equal to 0, means that we create independent layers, where no re-use of information is possible. Setting ρ equal to 1 is a known technique to create dependent layers in a scalable bit stream but hampers the attainment of the best quality.

The residual signal r₈ is fed to a second waveform encoder, here an RPE-2 stage with decimation factor 2. The RPE-2 stage creates an excitation signal x₂.

Ideally, the excitation x₈ computed in the RPE-8 encoder should be used in the decoder whenever it provides a reasonably good approximation of the residual r, otherwise, it is better for RPE-2 to discard it and operate directly on r rather than on r₈. This suggests that there should be a mechanism that assesses the quality as the resemblance or goodness-of-fit of x₈ with respect to r, i.e. how well r is modelled by x₈, and processes it accordingly in view of combining it with x₂. In its simplest form, this mechanism consists of just a simple gain. Below it is explained how the gain ρ, also referred to as the mixing coefficient, can be used and computed to evaluate and process x₈.

Finally, the parametric codes (SSC codes), the first excitation signal x₈, the second excitation signal x₂, the mixing coefficient ρ and preferably also the spectral flattening parameters are combined to form the encoded audio stream AS. Typically, the bit stream would then consist of three layers: a base parametric layer, a first refinement layer containing the first excitation signal, and a second layer containing the second excitation signal and the reusability of the first layer expressed in the parameter ρ.

The spectral flattening parameters need not be included in the audio bit stream. If such an audio stream without spectral flattening parameters is received in an audio player, the decoder in the audio player can determine the spectral flattening parameters by backward adaptation.

FIG. 7 shows a decoder according to the invention. The encoded audio stream AS is received, and its components, i.e. the parametric codes (SSC codes), the first excitation signal x₈, the second excitation signal x₂, the mixing coefficient ρ and the spectral flattening parameters, are identified and processed as follows.

The parametric codes are fed to a parametric decoder (SSC decoder) to decode the sinusoid and transient components. A spectral shaping filter, here an LPC synthesis filter, receives either the first excitation signal x₈ or a combined excitation signal (x₂+ρx₈). Using the received spectral flattening parameters the LPC synthesis filter regenerates the estimated SSC residual r′_{SSC} with its original shaped spectrum, and the estimated SSC residual r′_{SSC} is added to the decoded sinusoid and transient components to form the decoded signal. Additionally, a part of the parametric noise may be inserted into the excitation signal similar to the strategies employed in FIGS. 4 and 5.

One of the possible criteria of determining the usefulness of x₈ in the next RPE stage is its similarity with the input residual r. Consequently, it is natural that the gain ρ is somehow related to the correlation of these two signals. Setting the objective of removing the similarity between the signals r and x₈ (FIG. 4), an optimum value for ρ can be computed by as:

$$ρ = \frac{{\sum }_{k = 1}^{N} r ( k ) {x}_{8} ( k )}{{\sum }_{k = 1}^{N} {{x}_{8} ( k )}^{2}} \qquad ( 1 )$$

where x₈ and r are the signals thus identified in FIG. 6, and N denotes the window length over which ρ is optimised. The gain is preferably computed on a frame-by-frame basis, i.e. N is the frame length. It follows from eq. (1) that the optimum gain is just the correlation of x₈ and r normalised over the power of x₈. Other gains having similar properties to those of eq. 1 could also be defined (for example, the expression in eq. 1 is optimal in the sense of a squared error criterion; other criteria can be employed as well).

Notice that if the model of r provided by x₈ is perfect (i.e. r=x₈), then the mixing coefficient becomes one and r₈ becomes zero since there is no need for additional modelling. On the other hand, when x₈ is not a good model of r, the mixing coefficient will take a small value and the second RPE stage acts mostly on r rather than r₈, in other words, the decimation 2 layer makes only limited use of the information provided by the decimation 8 layer.

The technique described can be applied on the full bandwidth signal or particular frequency bands. The quality parameter ρ implies the possibility for complete filters for generating r₈ implying not a single but several parameters. The methods presented here carry over to layered bit streams that contain more than two excitation signals.

1. A method of encoding a digital audio signal, wherein for each time segment of the signal the following steps are performed:
encoding the audio signal to provide codes (SSC) representing the audio signal,
subtracting the codes from the audio signal to obtain a first residual signal (r_{SSC}),
spectrally flattening the first residual signal (r_{SSC}) to obtain a spectrally flattened residual signal (r) and spectral flattening parameters,
calculating, using a pulse train encoder, a first excitation signal from the spectrally flattened residual signal (r),
determining the quality of the first excitation signal (x₈) as its degree of resemblance with the spectrally flattened residual signal (r),
subtracting a part of the first excitation signal (x₈) from the spectrally flattened residual signal (r), to obtain a second residual signal (r₈), where the part depends on the determined quality of the first excitation signal (x₈),
calculating, using a pulse train encoder, a second excitation signal (x₂) from the second residual signal (r₈), and
generating an audio stream comprising
the first excitation signal (x₈),
the second excitation signal (x₂), and
a parameter (ρ) indicative of the quality of the first excitation signal (x₈).

2. A method according to claim 1, wherein the parametric codes comprise sinusoid and noise components of the audio signal.

3. A method according to claim 1, wherein the spectral flattening is done using linear predictive encoding (LPC).

4. A method according to claim 1, wherein the quality of the first excitation signal (x₈) is based on the correlation between the first excitation signal (x₈) and the spectrally flattened residual signal (r).

5. An audio encoder adapted to encode time segments of a digital audio signal, the encoder comprising:
an encoder for encoding the digital audio signal to provide codes (SSC) representing the signal,
a subtractor for subtracting a signal corresponding to the codes from the audio signal to obtain a first residual signal (r_{SSC}),
a spectral flattening unit for spectrally flattening the first residual signal (r_{SSC}) to obtain a spectrally flattened residual signal (r) and spectral flattening parameters,
a pulse train encoder for calculating a first excitation signal for the spectrally flattened residual signal (r),
means for determining the quality of the first excitation signal (x₈) as its degree of resemblance with the spectrally flattened residual signal (r),
a subtractor for subtracting a part of the first excitation signal (x₈) from the spectrally flattened residual signal (r), to obtain a second residual signal (r₈), where the part depends on the determined quality of the first excitation signal (x₈),
a pulse train encoder for calculating a second excitation signal (x₂) for the second residual signal (r₈), and
a bit stream generator (15) for generating an audio stream (AS) comprising:
the first excitation signal (x₈),
the second excitation signal (x₂), and
a parameter (ρ) indicative of the quality of the first excitation signal (x₈).

6. An audio encoder according to claim 5, wherein the parametric codes comprise sinusoid and noise components of the audio signal.

7. An audio encoder according to claim 5, comprising a linear predictive encoder (LPC) adapted to perform the spectral flattening.

8. An audio encoder according to claim 5, wherein the fraction (ρ) is based on the correlation between the first excitation signal (x₈) and the spectrally flattened residual signal (r).

9. A method of decoding a received audio stream (AS), where the audio stream comprises for each of a plurality of segments of an audio signal:
a first excitation signal (x₈),
a second excitation signal (x₂), and
a parameter (ρ) indicative of the quality of the first excitation signal (x₈), the method comprising:
combining, in dependence on the quality parameter (ρ), the first and second excitation signals (x₈, x₂) to obtain a combined excitation signal, and
synthesizing from the combined excitation signal, using linear prediction, a first residual signal (r′_{SSC}).

10. An audio player for receiving and decoding an audio stream (AS), where the audio stream comprises for each of a plurality of segments of an audio signal:
a first excitation signal (x₈),
a second excitation signal (x₂), and
a parameter (ρ) indicative of the quality of the first excitation signal (x₈), the audio player comprising
means for combining, in dependence on the quality parameter (ρ), the first and second excitation signals (x₈, x₂) to obtain a combined excitation signal, and means for synthesizing from the combined excitation signal, using linear prediction, a first residual signal (r′_{SSC}).

11. An audio stream (AS) comprising for each of a plurality of segments of an audio signal:
a first excitation signal (x₈) resulting from pulse train encoding of a spectrally flattened residual signal (r), the residual signal (r) resulting from subtracting an encoded audio signal from the audio signal,
a second excitation signal (x₂) resulting pulse train encoding a second residual signal, said signal generated by subtracting a part of the first excitation signal (x₈) from the spectrally flattened residual signal (r), where the part depends on a determined quality of the first excitation signal (x₈), and
a parameter (ρ) indicative of the determined quality of the first excitation signal (x₈).

12. A storage medium having an audio stream (AS) as claimed in claim 11 stored thereon.
